(19) United States
(12) Patent Application Publication
(10) Pub. No.: US 2026/0074519 A1
(43) Pub. Date: Mar. 12, 2026

(54) SYSTEMS AND METHODS FOR POWER PLANT OPTIMIZATION

(71) Applicant: Nextracker LLC, Fremont, CA (US)

(72) Inventors: Gayathri Indra Seenumani, Fremont, CA (US); Ramon YLL PROUS, Newport Beach, CA (US); Mustafa T. Dokucu, Fremont, CA (US); Alexander W. Au, Oakland, CA (US)

(21) Appl. No.: 19/320,468

(22) Filed: Sep. 5, 2025

Related U.S. Application Data
(60) Provisional application No. 63/692,974, filed on Sep. 10, 2024.

(51) Int. Cl. H02J 3/32; H02J 3/38

(52) U.S. Cl. CPC H02J 3/32; H02J 3/381; H02J 2101/25

(57) ABSTRACT

A method of optimizing control of a power plant includes receiving a request for power plant output power, receiving first power block data from a first power block, receiving second power block data from a second power block, determining an optimized set of power setpoints for one or more power block components of the first power block and the second power block, and setting the power setpoints for the one or more power block components of the first power block and the second power block based on the determined optimized set of power setpoints. The first power block and second power block can each include a PV system, a battery system, and at least one inverter. The optimized set of power setpoints can be based on the first power block data, the second power block data, and the requested power plant output power.

### RELATED APPLICATIONS

This application claims priority to U.S. Provisional Patent Application No. 63/692,974, filed Sep. 10, 2024, the contents of which are hereby incorporated by reference.

### TECHNICAL FIELD

This disclosure generally relates to optimizing power plant systems.

### BACKGROUND

Managing and controlling large solar arrays can present significant challenges. One of the primary difficulties is optimizing energy output from the solar panels, which are subject to varying environmental conditions, such as changes in sunlight intensity and temperature. To address this, solar arrays often include tracking to track the sun as it moves across the sky. Additionally, Maximum Power Point Tracking (MPPT) algorithms are employed to continuously adjust the operating parameters of the solar panels to extract the maximum possible power. However, as the size of a solar array increases, the complexity of maintaining optimal performance across all panels becomes more pronounced, often leading to inefficiencies and reduced overall output.

Another layer of complexity is introduced when integrating energy storage systems, such as batteries, with a solar array. These storage systems can be useful for balancing supply and demand, particularly when there is a mismatch between the energy produced by the solar array and the energy demanded by the power grid. However, coordinating the charging and discharging of batteries while simultaneously managing the output of the solar array to align with power demands from the grid presents unique challenges.

### SUMMARY

In general, this disclosure describes systems and methods for photovoltaic and battery flow optimization. The systems and methods presented herein can maximize a throughput of power from a PV system and/or a combined PV and battery system by optimizing power setpoints of connected inverters, converters, and/or batteries of the system.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic view of an example power plant system according to an aspect of the present disclosure.

FIG. 2 is an example graph of a maximum active power and reactive power provided by an example power plant system according to an aspect of the present disclosure.

FIG. 3 is a flow diagram of an example method of optimized control of setpoints in a power plant according to an aspect of the present disclosure.

FIG. 4A is an example graph of power provided by PV power blocks under varying conditions according to an aspect of the present disclosure.

FIG. 4B is an example graph of power provided by the PV power blocks of FIG. 4A under further varying conditions according to an aspect of the present disclosure.

FIG. 5A is a flow diagram of an alternate example method of optimized control of setpoints in a power plant according to an aspect of the present disclosure.

FIG. 5B is a continuation of the flow diagram of FIG. 5A.

FIG. 6A is an example graph of power provided by a power plant system including batteries under charging conditions according to an aspect of the present disclosure.

FIG. 6B is an example graph of power provided by the power plant system of FIG. 6A including batteries under discharging conditions according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

In this disclosure, DC/DC converters generally refer to electronics that can convert a first DC voltage to a second DC voltage. Similarly, DC/AC inverters (also referred to as DC/AC converters) generally refer to electronics that can convert a DC voltage to an AC voltage.

This disclosure generally describes a power plant system including power blocks that are controlled to maximize energy production. The power blocks include solar panels for producing energy, optional batteries for storing energy, and at least one inverter for converting energy produced and/or stored by the power blocks and that is in communication with a grid (e.g., electrical utility). The power plant system includes a controller, such as a power plant controller (PPC), that is configured to communicate with the power blocks, including the at least one inverter and DC/DC converters that control charging and discharging of the optional batteries. The controller can provide setpoints to the at least one inverter, the optional DC/DC converters, or the batteries of each block to meet grid demand for energy and to maximize energy production of the power plant system. Utilizing the setpoints, the controller can unevenly split and provide active/reactive power to the grid from the power blocks, selectively charge/discharge batteries of each power block depending on a variety of factors, and minimize the curtailment of solar power. Throughout this disclosure, a PPC is described as performing various functions of the power plant system. However, as a person having ordinary skill in the art will appreciate, any controller or controllers can be configured to perform such functions.

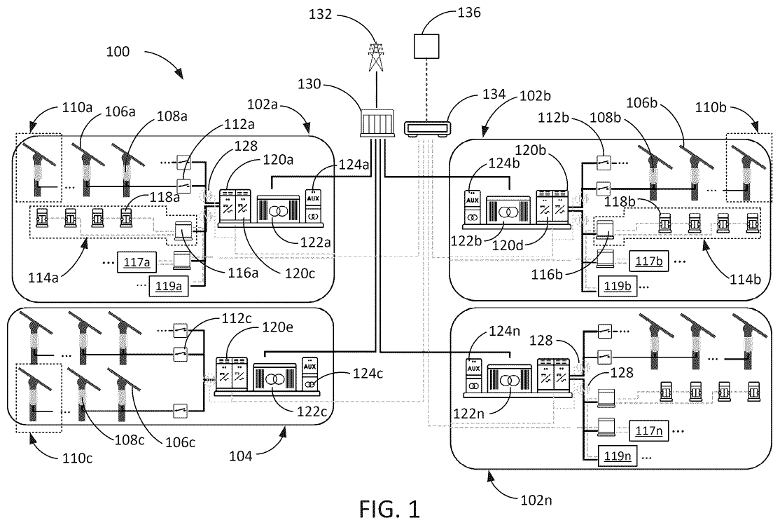

FIG. 1 is a schematic view of an example power plant system 100 according to an aspect of the present disclosure. The power plant system 100 includes a series of power blocks 102a, 102b, 102n, 104. In the series of power blocks, a first power block 102a includes a PV system that comprises PV panels 106a (also referred to as “solar panels), devices 108a implementing maximum power point tracking (MPPT), and solar tracking components (e.g., torque tube, motor, etc.) that enable the PV panels 106a to move and track the sun as the sun moves across the sky. In the illustrated example, a first solar tracker 110a includes PV panel(s) 106a, solar tracking components, and a DC/DC converter 108 operating to perform MPPT for the first solar tracker 110a. As indicated by the ellipsis, the first power block 102a can include any number of solar trackers and associated components (e.g., PV panels 106a, solar tracking components, and DC/DC converters 108).

In some examples, a solar tracker includes multiple PV panels, solar tracking components, and DC/DC converters 108. For instance, the first solar tracker 110a can include a row of PV panels, solar tracking components such as a torque tube and motor that can be commonly used by the row of PV panels, and DC/DC converters for each PV panel within the row of PV panels. However, while a DC/DC converter 108 can be part of each solar tracker and/or can be used for each PV panel 106a, a DC/DC converter for performing MPPT can be separate from a solar tracker and in some examples, is electrically connected to multiple solar trackers to perform MPPT on the multiple solar trackers. For instance, a DC/DC converter or other device configured to perform MPPT can be connected to a string of solar trackers and perform MPPT on the string of solar trackers as a whole, rather than for each solar tracker individually. In some examples, a device performing MPPT can be part of another device. For instance, in some examples, an inverter can perform MPPT.

The power plant system 100 can also include electrical connections that can combine any number of PV panels together. For instance, in the illustrated example, the solar trackers are electrically connected together into strings of solar trackers. A PV system includes one or more solar trackers, such as a string of solar trackers electrically connected together. Such a PV system can include switches 112a that connect each string of solar trackers to a common electrical connection such as a DC bus. The switches 112a can enable connection/disconnection of a string of solar trackers with other electrical components within the first power block 102a.

The power plant system 100 can further include a DC bus, which is common to various components of each power block. For example, the first power block 102a includes a common DC bus to which various components can be electrically connected, including the solar trackers 110a. The common DC bus can have a common DC voltage. The common DC voltage can be a fixed DC voltage or a variable DC voltage. In some examples, the DC voltage across the common DC bus is generally constant but can be adjusted up or down in response to various measurements and/or conditions, as is discussed further elsewhere herein.

The first power block 102a also includes a first battery system 114a that includes a DC/DC converter 116a and one or more batteries 118a. The DC/DC can convert power generated and/or stored by the one or more batteries 118a at a first DC voltage and output and/or receive power at a second DC voltage (e.g., at a DC bus). The one or more batteries 118a can include one or more battery controllers to control aspects of the batteries 118a. The batteries 118a are also referred to herein as batteries/battery controllers 118a as each battery generally includes an associated battery controller. The battery system 114a can also include one or more sensors for sensing various parameters of any connected batteries 118a. The one or more sensors can include voltage sensors, current sensors, battery health sensors, battery temperature sensors, and the like. Accordingly, the one or more sensors can measure a battery state of charge, a battery voltage, a battery current, a battery charge rate, a battery discharge rate, a battery health, and/or the like. The one or more sensors can be included in the one or more batteries/battery controllers 118a and/or included in the DC/DC converter 116a. In some examples, the DC/DC converter 116a can be configured to determine one or more of a battery state of charge, a battery health, a battery voltage, a battery current, a battery charge rate, a battery discharge rate, or the like using, for example, data from the one or more sensors.

The first battery system 114a can also include communication components to electrically communicate (e.g., wired or wirelessly) with other components of the power plant system 100. For example, the first battery system 114a can include wired or wireless communications with the one or more batteries 118a, the one or more battery controllers, the one or more sensors, and/or the DC/DC converter 116a. In some examples, the one or more data from the one or more sensors can be communicated to other components of the power plant system 100.

In some examples, rather than a battery (e.g., chemical battery), the battery system 114a includes other energy storage systems that can store energy and optionally, release energy. For instance, the battery system can include flow batteries (e.g., vanadium flow batteries) hydrogen generation (e.g., electrolysis), pumped hydro, mechanical storage (e.g., flywheels), thermal storage, and/or others. In some examples, the battery system 114a can include other components that use energy (e.g., electrical loads). While four batteries and a single DC/DC converter are illustrated as being part of the first battery system 114a, any number of batteries, battery controllers, and DC/DC converters can be used. For example, a first battery system can include all batteries, battery controllers, and DC/DC converters within the first power block 102a. The DC/DC converter 116a can be connected to any number of batteries and associated battery controllers.

The first power block 102a can also include other components connected to a DC/DC converter (e.g., 116a) and/or connected to a DC bus. For instance, the first power block 102a can include one or more converter-connected components 117a. The one or more converter connected components 117a generally connect to a DC/DC converter before connecting to the DC bus of the first power block 102a. Such converter-connected components 117a may use, output, and/or operate at a different voltage than the common DC bus operates. Accordingly, the associated DC/DC converter can convert DC voltages of the converter-connected components to the voltage at which the common DC bus operates and/or can convert the voltage at which the common DC bus operates to voltages of the converter-connected components. While only one converter-connected component 117a is illustrated, the first power block 102a can include any number of converter-connected components. Further, any number of converter-connected components can be connected to any number of corresponding DC/DC converters (e.g., 116a).

In some examples, multiple converter-connected components 117a can be connected together. For instance, a converter-connected component can be an energy storage device (e.g., vanadium flow battery) with multiple energy storage devices electrically connected together in series and/or parallel. In examples including multiple converter-connected components 117a, the multiple converter-connected components can be connected together (e.g., in series and/or parallel) and/or can be connected to a common DC/DC converter. Converter-connected components can include energy storage devices, such as batteries (e.g., lithium-ion, vanadium flow), thermal storage systems, hydrogen generation/storage, and mechanical systems (e.g., flywheels, pumped hydro power). Converter-connected components can also include electrical loads that do not specifically store energy, such as lighting, motors, and heating/cooling systems (e.g., for buildings). A person having ordinary skill in the art will appreciate that other converter-connected components are contemplated, and that this disclosure is not limited to the listed examples.

The first power block 102a can also include one or more DC bus-connected components 119a. In contrast to the one or more converter-connected components 117a, the one or more DC bus-connected components 119a generally connect directly to a DC bus of the first power block 102a. Such bus-connected components 119a can operate at the voltage of the DC bus and/or can include their own converter(s) (e.g., DC/DC converters) to enable the bus-connected components 119a to connect directly to the DC bus. While only one bus-connected component 119a is illustrated, the first power block 102a can include any number of bus-connected components.

In some examples, multiple bus-connected components 119a can be connected together. For instance, a bus-connected component can be a hydrogen generation system with multiple hydrogen generation systems connected together. Bus-connected components can include energy storage devices, such as batteries (e.g., lithium-ion, vanadium flow), thermal storage systems, hydrogen generation/storage, and mechanical systems (e.g., flywheels, pumped hydro power). Bus-connected components can also include electrical loads that do not specifically store energy, such as lighting, motors, and heating/cooling systems (e.g., for buildings). A person having ordinary skill in the art will appreciate that other bus-connected components are contemplated, and that this disclosure is not limited to the listed examples.

While element 116a is illustrated as being a DC/DC converter, in some examples, element 116a includes a controller with an integrated DC/DC converter. For instance, element 116a can include a battery controller with an integrated DC/DC converter. In some examples, element 118a includes communication components and is in communication with the DC/DC converter 116a. The DC/DC converter 116a can similarly include communication components to communicate with other components of the power plant system 100. For instance, the DC/DC converter 116a can include communication components that communicate with converter-connected components 117a. In some examples, element 118a comprises a battery controller including a DC/DC converter that is then connected to the element 116a, which comprises a second DC/DC converter. Such a system can enable further adjustment of voltage output by a battery or batteries such as, for example, to increase DC output voltage to a DC bus voltage. The element 116a, when functioning as a DC/DC converter, can increase an input voltage (e.g., from batteries/battery controller 118a) to an output voltage consistent with a DC bus voltage, to which the element 116a is connected.

Continuing with the first power block 102a, the first power block 102a includes a first AC/DC converter 120a, also referred to as a first inverter 120a. The first inverter 120a is connected to the solar trackers 110a and the first battery system 114a of the first power block 102a. The first inverter 120a can be connected to a common bus to which both the solar trackers 110a and the first battery system 114a are also connected. The common bus can be a common DC bus that carries a common DC voltage. In some examples, the first inverter 120a can itself include a common DC bus to which the solar trackers 110a and the first battery system 114a are connected.

The first inverter 120a is also connected to a transformer 122a. The transformer 122a can be part of a grid connection, such as an electrical utility, and be configured to transform AC power at one voltage to AC power at a different voltage. The transformer 122a can be electrically connected to an auxiliary system 124a that is also part of a grid connection (e.g., electrical utility). In some examples, the auxiliary system 124a includes sensors for measuring aspects of the transformer such as input power and output power. In some examples, the auxiliary system 124a includes a controller for controlling aspects of the transformer. In some examples, the auxiliary system 124a includes communication components (e.g., networking) for communicating with a grid (e.g., utility provider) and can receive commands from the grid such as a request for active and/or reactive power.

The first inverter 120a can include a controller and communication components to communicate with other components of the power plant system 100. In some such examples, the controller of the first inverter 120a can send and receive commands using the communication components.

The first inverter 120a is configured to both convert DC power to AC power and convert AC power to DC power. The connections to the first inverter 120a can be both inputs and outputs. For instance, the first inverter 120a can receive at an input DC power generated by the solar trackers 110a and can convert the DC power to AC power and output the AC power (e.g., to a grid). The first inverter 120a can also receive at an input AC power (e.g., from a grid) and can convert the AC power to DC power and output the DC power to the first battery system 114a to store the DC power. However, in some examples, the first inverter 120a is limited to either converting DC power to AC power or converting AC power to DC power at one time. For instance, the first inverter 120a may be unable to receive DC power from the solar trackers 110a and convert the DC power to AC power (e.g., for output to the grid) while also receiving AC power (e.g., from the grid) and converting the AC power to DC power to be stored in the first battery system 114a.

The first inverter 120a can be configured with power setpoints. As described herein, a power setpoint can be defined as a setpoint that affects aspects of an inverter. For instance, in some examples, the power setpoint can include one or more of a voltage, a current, a frequency, an impedance, an active power, a reactive power, a power factor, or the like. Similarly, in some examples, a set of power setpoints can include one or more (e.g., multiples of) voltages, currents, frequencies, impedances, active powers, reactive powers, power factors, or the like. In some examples, the first inverter 120a can control its own power setpoint(s) via a controller. Additionally or alternatively, in some examples, the first inverter 120a can be commanded to control the power setpoint(s) via communication with other components of the power plant system 100.

As described elsewhere herein, the first inverter 120a can be connected to a common DC bus along with the solar trackers 110a and the first battery system 114a. Further, the common DC bus can have a voltage that is fixed or that is adjustable. In some embodiments, the first inverter 120a can be configured to adjust the voltage of the common DC bus. The adjustment of the voltage of the common DC bus can be set via a power setpoint, or setpoints, of the first inverter 120a. For instance, the first inverter 120a can have a power setpoint that adjusts a voltage of the DC bus from 1400V DC to a higher voltage (e.g., 1500V DC) or lower voltage (1300V DC). The power setpoint(s) of the first inverter 120a can be changed at any time and can be dynamically adjusted. For example, the power setpoint(s) of the first inverter 120a can be dynamically adjusted based on data (e.g., measurements) from components of the first power block 102a.

While the first inverter 120a is described as being connected to and configured to adjust a voltage of a common DC bus, in some examples, the first inverter 120a can individually adjust voltages of connected components. For instance, the first inverter 120a can adjust a voltage of the solar trackers associated with a first switch 112a (e.g., a first string of solar trackers) separately from a voltage of solar trackers associated with a different switch and separately from a voltage of the first battery system 114a. In another example, the first inverter 120a can adjust a voltage of each DC/DC converter 116a separately from a voltage of connected solar trackers, separately from converter-connected components, and/or separately from bus-connected components. A power setpoint or setpoints of the first inverter 120a can include multiple voltages (e.g., one per connection) with the voltages being the same or different from each other. The power setpoint, though, is not limited to voltages. The power setpoint of the first inverter 120a can include multiple currents, frequencies, impedances, active powers, reactive powers, power factors, or the like.

In some examples, the first power block 102a includes multiple inverters. For instance, in the illustrated example, the first power block 102a includes an additional inverter 120c. The additional inverter 120c can be coupled to the first inverter 120a in parallel to increase the electrical capacity of the first power block 102a to convert DC power to AC power and AC power to DC power. Alternatively, the additional inverter 120c can be separate from the first inverter 120a and connected to components (e.g., solar trackers, battery systems) that are separate from the first inverter 120a. In some such examples, the additional inverter 120c can be connected to a DC bus that is separate from a DC bus connected to the first inverter. In some examples, the additional inverter 120c can be in communication (e.g., via a wired or wireless connection) with the first inverter 120a to, for example, communicate data.

The additional inverter 120c can be configured in the same manner as the first inverter 120a. For instance, the additional inverter 120c can be configured with a power setpoint or setpoints that can include voltages, currents, frequencies, impedances, active powers, reactive powers, power factors, or the like. In some embodiments, the additional inverter 120c is configured to have the same power setpoint(s) as the first inverter 120a. In some embodiments, the first inverter 120a can function as a controller inverter while the additional inverter 120c can function as a peripheral inverter that is controlled at least in part by the controller inverter. For example, the first inverter 120a can send a power setpoint or setpoints to the additional inverter 120c with the additional inverter 120c receiving the power setpoint(s). The additional inverter 120c can then match the power setpoint(s) of the first inverter 120a to control, for example, control voltages of connected components. If the additional inverter 120c is connected to an additional DC bus that is separate from the DC bus connected to the first inverter 120a, the additional inverter 120c can match the power setpoint(s) of the first inverter to control a voltage of the additional DC bus to control components coupled thereto. In some examples, any number of additional inverters can be used that function as peripheral inverters controlled at least in part by a controller inverter (e.g., first inverter 120a) or can act in additional controller/peripheral configurations.

The first power block 102a can also include one or more meters 128. The one or more meters 128 can be configured to measure one or more of a voltage, current, or power of various components of the first power block 102a. For instance, the one or more meters 128 can measure an output power of solar trackers 110a. A meter 128 can be connected and configured to measure an individual solar tracker, a string of solar trackers, and/or all the solar trackers within the first power block 102a. In FIG. 1, an individual meter 128 is used to measure an output power of all solar trackers within the first power block 102a.

The one or more meters 128 can also be used in conjunction with the battery system 114a. For instance, the one or more meters 128 can measure a voltage, current, and/or power associated with the battery system 114a. In some examples, the one or more meters 128 measure an output power from the batteries and an input power into the batteries. In some examples, a meter 128 can be connected and configured to measure an individual battery, a string of batteries, and/or all the batteries within the first power block 102a. In FIG. 1, an individual meter is used to measure output power and input power of all the batteries within the first power block 102a.

The one or more meters 128 can also be used in conjunction with converter-connected components 117a, the converters themselves (e.g., 116a), and bus-connected components 119a. For example, a bus-connected component 119a can comprise an electrical load with one or more meters measuring a voltage, current, and/or a power consumption of the electrical load.

The one or more meters 128 can also be used as a whole to measure the solar trackers 110a, the battery system 114a, and/or other connected components (e.g., converter-connected components 117a, bus-connected components 119a). For example, the one or more meters 128 can measure a voltage of a DC bus to which all of the solar trackers 110a and the battery system 114a are ultimately connected. As the DC bus is common, the one or more meters 128 can measure the voltage, current, and/or power of the DC bus and thereby measure a performance of the first power block 102a as a whole.

While illustrated as being separate elements, the meters 128 can be a part of other components of the first power block 102a. For example, the meters 128 can be integrated with the devices 108a implementing MPPT, can be integrated with the inverters 120a, 120b, can be integrated with the DC/DC converters 116a, and/or can be integrated with the batteries/battery controllers 118a. Further, any number and type of meters 128 can be included in the first power block 102a.

The meters 128 can be configured to communicate their measurements of voltage, current, power, etc. with other parts of the power plant system 100. To communicate with the other parts of the power plant system 100, the meters can include communication components themselves and/or be part of a component that includes communication components. For example, if the meters are integrated into an inverter, the inverter can communicate measurements taken by the integrated meter(s) with other parts of the power plant system 100.

Continuing with the example power plant system 100 of FIG. 1, the power plant system 100 includes the second power block 102b. The second power block 102b can include similar, if not the same, components as the first power block 102a. For example, the second power block 102b includes second PV panels 106b, second devices (e.g., DC/DC converters) 108b for implementing maximum power point tracking (MPPT), and second solar tracking components (e.g., torque tube, motor, etc.) that enable the second PV panels 106b to move and track the sun across the sky. The second power block 102b also includes a second solar tracker 110b that can include a row of PV panels, solar tracking components, and DC/DC converters for each PV panel, or for the single row of PV panels. The second power block 102b further includes second switches 112b for connecting/disconnecting strings of solar trackers with/from other electrical components within the second power block 102b. Additionally, the second power block 102b includes a second battery system 114b that includes a second DC/DC converter 116b, one or more batteries 118a, and one or more battery controllers (e.g., as part of the one or more batteries 118a). The second power block 102b can also include one or more second converter-connected components 117b and/or one or more second bus-connected components 119b. The second battery system 114b can be configured in the same manner as the first battery system 114a. The second power block 102b also includes a second AC/DC converter 120b, also referred to as second inverter 120b. The second inverter 120b can be configured similarly to the first inverter 120a. In some examples, the second power block 102b includes an additional inverter 120d that can be configured in the same manner as the additional inverter 120c of the first power block 102a (e.g., in a controller/peripheral configuration). The second power block 102b can also include any number of additional inverters that can act in one or more controller/peripheral configurations and/or be configured with the same power setpoint(s). The second power block 102b further includes a transformer 122b connected to a grid (e.g., electric utility) and an auxiliary system 124b electrically connected to the transformer. The transformer 122b of the second power block 102b is connected to the same grid as the first power block 102a, though it need not be. The second power block 102b also includes meters 128 that can be configured in a comparable manner as the meters 128 of the first power block 102a.

The power plant system 100 of FIG. 1 also includes a fourth power block 104 that is different from the first power block 102a and the second power block 102b. The fourth power block 104 includes fourth PV panels 106c, fourth devices (e.g., DC/DC converters) 108c for implementing maximum power point tracking (MPPT), and fourth solar tracking components (e.g., torque tube, motor, etc.) that enable the fourth PV panels 106c to move and track the sun across the sky. The fourth power block 104 also includes a fourth solar tracker 110c that can include a row of PV panels, solar tracking components, and DC/DC converters for each PV or for the single row of PV panels (e.g., string level). The fourth power block 104 also includes fourth switches 112c for connecting/disconnecting strings of solar trackers with/from other electrical components within the fourth power block 104. However, in comparison to the first power block 102a and the second power block 102b, the fourth power block 104 does not include a battery system.

The fourth power block 104, though, still includes an AC/DC converter 120e, also referred to as a fourth inverter 120e. The fourth inverter 120e can be configured similarly to the first inverter 120a and the second inverter 120b. The fourth power block further includes a transformer 122c connected to a grid (e.g., electric utility) and an auxiliary system 124c electrically connected to the transformer 122c. The transformer 122c of the fourth power block 104 is connected to the same grid as the first power block 102a and the second power block 102b, though it need not be. The fourth power block 104 can also include meters 128 that can measure a voltage, current, power etc. of the components (e.g., solar trackers) of the fourth power block 104.

As illustrated, the power plant system 100 of FIG. 1 can include an “n” number of power blocks 102n. In general, a power block is defined as all the components (e.g., solar trackers, battery systems, converter-connected components, bus-connected components, inverter) connected to a single transformer (e.g., AC/AC transformer) that is connected to a grid. In FIG. 1 for example, the first power block 102a, the second power block 102b, and the fourth power block 104 are each connected to their own individual transformer. However, in some examples, a power block can be defined as all the components connected to a number of transformers (e.g., two, three) and/or all the components connected to a single inverter (e.g., first inverter 120a).

The “n” number of power blocks in the power plant system can include similar components as those already described with respect to the first, second, and fourth power blocks and can be configured similarly. For instance, the n^{th} power block 102n can be a third, fourth, fifth, etc. power block configured in a similar or the same manner as the first power block 102a and the second power block 102b. While each power block 102a, 102b, 102n can include similar components (e.g., solar trackers, battery system, converter-connected components, bus-connected components, inverter(s)), the type and number of components can vary from power block to power block and is not limited. For instance, one power block can include solar trackers, a battery system, and an electric load while another power block includes solar trackers, an energy storage system, and no electric load.

A power block can be classified based on the components connected thereto. For example, a solar power block (e.g., 104) may include solar trackers, but not include a battery system, converter-connected components, or bus-connected components. A battery power block may include a battery system, but not include solar trackers, converter-connected components, or bus-connected components. A solar +battery power block may include both solar trackers and a battery system, but not include converter-connected components or bus-connected components. A hybrid power block may include solar trackers, a battery system, and a converter-connected or bus-connected component. As will be appreciated, a power block can include a single type or multiple types of components (e.g., solar tracker components, battery system components, converter-connected components, bus-connected components, etc.) and can further include any number of such components (e.g., two battery systems).

Continuing with the example power plant system 100 of FIG. 1, the transformers of each power block are electrically connected to a power plant point of interconnect (POI) 130. The POI 130 can include various electrical components but acts as a point to which each power block connects to a grid/utility connection. For instance, the POI 130 can include switchgear that connects the AC outputs of each transformer of each power block. The POI 130 is electrically connected to the rest of the grid/utility 132. As will be appreciated, any number and type of power blocks can be connected to the POI 130 to connect the power blocks to a grid/utility 132.

The example power plant system 100 of FIG. 1 also includes a power plant controller (PPC) 134. In general, a PPC is a controller that can communicate with one or more components/systems of a power plant system 100. While a PPC is illustrated, any controller or controllers can be used to connect to various aspects of the power plant and perform the functions described with respect to the PPC. In some examples, a controller or controllers can be integrated with a PPC such that some functions are controlled by the PPC while other functions are controlled by the integrated controller or controllers. The PPC 134 can include communication (e.g., networking) components that enable the power plant controller to be in communication with the various parts of the power plant system 100 and with a grid controller 136. While a specific controller in communication with the PPC 134 is illustrated, the grid controller 136 generally represents electrical communication with a grid. Such electrical communication can take many forms as a person having ordinary skill in the art will appreciate. The communication between components can include wired or wireless communication and is not limited by a specific communication protocol. As illustrated by the dashed lines, the PPC 134 is in communication with the inverter(s) of each power block and the DC/DC converters of each battery system. The PPC 134 can also be in communication with each battery/battery controller (e.g., 118a) of each power block. In some examples, the PPC 134 is in communication with one or more DC/DC converters of converter-connected components (e.g., 117a) and/or with the one or more converter-connected components themselves. Similarly, in some examples, the PPC 134 is in communication with one or more bus-connected components (e.g., 119a). Further, in some examples, the PPC 134 is in communication with the meters 128 of each power block. The PPC 134 can send and receive communications to/from each of the devices connected thereto including the inverters, the DC/DC converters, the batteries/battery controllers, the converter-connected components, the bus-connected components, and the meters. While not specifically illustrated, in some embodiments, the PPC 134 is in communication with one or more devices implementing MPPT (e.g., device 108a). Further, while connections with the PPC 134 are illustrated as being a mix of individual and joined connections, the connections are merely for illustration purposes and do not limit how the PPC 134 connects with the various components of the power plant system 100. For instance, the PPC 134 may connect and communicate with a meter via a connection with an inverter.

While only one PPC 134 is illustrated as being in communication with the described components of each block, any number of PPCs can be used. For instance, one PPC can be used per power block, whereby a single PPC communicates with the inverter(s), the DC/DC converter(s), the batteries/battery controllers, and the optional meter(s) of an individual power block. Additionally or alternatively, one PPC can be used per multiple power blocks. In examples using multiple PPCs, the PPCs can be in communication with each other. In some examples, a distributed PPC system is used to communicate with the inverter(s), the DC/DC converter(s), the battery/battery controller(s), and the optional meter(s) of connected power blocks. Such a system can include multiple PPCs (e.g., one per power block) in communication with each other and/or in communication with a central controller. Such a central controller can send instructions to each PPC such that each PPC performs a desired function substantially simultaneously. Using a distributed power plant control system can reduce communication delays, especially when more power blocks are part of a power plant system. A person having ordinary skill in the art will appreciate that other combinations of PPCs are contemplated and that this disclosure is not limited to the described examples.

In operation, the PPC 134, or other controller(s), monitors and controls various aspects of the power plant system 100. In general, the PPC 134 can monitor aspects (e.g., output power) of the power blocks 102a, 102b, 102n, 104 and provide setpoints to one or more inverters (e.g., first inverter 120a) and one or more DC/DC converters (e.g., DC/DC converter 116a) of the power blocks to meet grid demand for energy and/or to maximize/optimize energy production of the power plant system 100. The PPC 134 can also monitor aspects of the batteries such as type of batter, voltage, current, state of charge, health, charge/discharge rate, and/or the like (e.g., using sensors) and selectively charge/discharge batteries of each power block to similarly meet grid demand for energy and/or to maximize energy production of the power plant system 100. Additionally or alternatively, the PPC 134 can selectively charge/discharge batteries of each power block to meet other objectives such as, for example, minimizing response time, maximizing battery health, maximizing a profit of generated/stored electricity, and minimizing curtailment of solar power. These and other operations of the PPC 134 are discussed elsewhere herein.

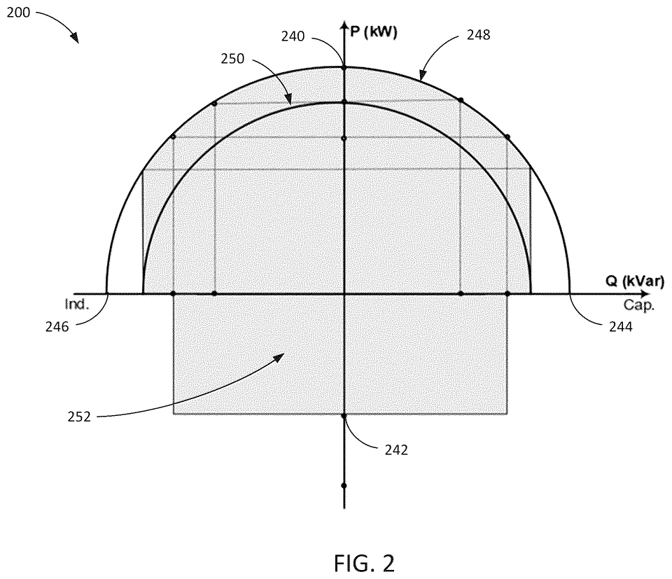

FIG. 2 is an example graph of a maximum active power and reactive power provided by an example power plant system (e.g., 100) according to an aspect of the present disclosure. Referring to both FIG. 1 and FIG. 2, a PPC 134, or other controller(s) can be configured to operate an example power plant system 100 within a specific envelope 200 of maximum active and reactive power. Operating within the envelope 200 of maximum active and reactive power can prevent damage to components of the power plant system 100. The envelope 200 is defined by a maximum positive active power 240, a maximum negative active power 242 (e.g., charging batteries), a maximum positive reactive power 244, and a maximum negative reactive power 246. For positive active power, the maximum positive and negative reactive power can generally be limited by an outer curve 248. This outer curve 248 indicates the maximum apparent power. However, as illustrated by the shaded area and the inner curve 250, in some examples, the maximum apparent power is limited under certain temperatures to avoid damage to components of the power plant system 100. Negative active power, as indicated by the shaded area 252, is generally limited by charging of batteries within the power plant system 100. Accordingly, for negative active power, the maximum positive and negative reactive power can be limited further than the maximum positive and negative reactive power for positive active power. This again can be useful to prevent damage to components of the power plant system 100, such as the battery system (e.g., 114a). While a specific envelope 200 of maximum active and reactive power is illustrated, this disclosure is not limited to the illustrated example. For instance, for negative active power, the maximum positive and negative reactive power can be limited by a curve in similarity with the positive active power curve (e.g., 248, 250).

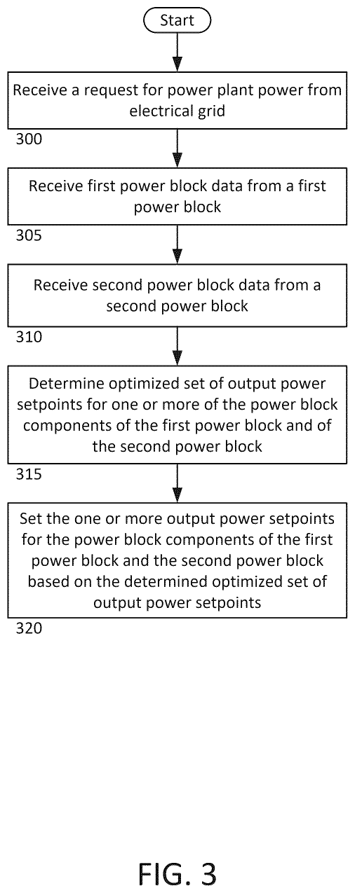

FIG. 3 is a flow diagram of an example method of optimized control of setpoints in a power plant according to an aspect of the present disclosure. Referring to both FIG. 1 and FIG. 3, a PPC 134 can be configured to operate an example power plant system consistent with the method of FIG. 3. It is contemplated, though, that another controller and/or multiple controllers (e.g., multiple PPCs) can be configured to operate a power plant system consistent with the method of FIG. 3. Further, while the method is described with respect to the example power plant of FIG. 1, the method of FIG. 3 is not limited to the specific example power plant of FIG. 1.

Flow of the method can start at 300 with receiving a request for power plant power from an electrical grid. In an example, a grid controller 136, or the grid in general, can communicate with the PPC 134 the request for power plant power. The request can include both active and reactive power and, in some examples, can include a power factor and/or frequency. Further, in some examples, the request can include a time associated with the request. For instance, a grid request can include a request for active and/or reactive power at a future time (e.g., a predicted request for power).

Flow continues at 305 whereby a PPC 134 can receive first power block data from a first power block (e.g., 102a). As described elsewhere herein, a power block can include power block components such as a PV system comprising solar trackers (e.g., 110a), a battery system (e.g., 114a) including batteries (e.g., 118a) and DC/DC converters (e.g., 116a), converter-connected components (e.g., 117a), bus-connected components (e.g., 119a), and at least one inverter (e.g., 120a). A power block can also include one or more meters (e.g., 128) for measuring voltages, currents, power, and the like from the power block components. The first power block data received from the first power block can include data relating to the first power block components. The PPC 134 can communicate with one or more of these components to receive the first power block data. For example, the components of the first power block can include networking components to send/receive data to/from the PPC 134 via wired or wireless communication.

The first power block data can include an available first output power of the PV system. In some examples, the available output power of the PV system can be defined as a maximum output power of the PV system in the current conditions (e.g., immediately available) and/or in future conditions (e.g., likely available in the future). The available output power of the PV system can be measured directly or indirectly. For instance, the one or more meters 128 can directly measure a voltage and current of each solar tracker, a string of solar trackers, a PV system, or an entire PV system of a power block to determine an available output power. In other examples, the available output power can be determined by measuring a voltage of a common DC bus to which the PV system is connected and estimating the available output power using such a measurement.

The first power block data can also include an available battery system output power. In some examples, the available battery system output power can be defined as a maximum output power of the battery system in the current conditions (e.g., immediately available) and/or in future conditions (e.g., likely available in the future). In similarity with the available output power of the PV system, the battery system output power can be measured directly or indirectly. For instance, the one or more meters 128 can directly measure a voltage and current of each battery, a string of batteries, a battery system, or an entire battery system of a power block to determine an available output power. In other examples, the available output power can be determined by measuring a voltage to which the battery system is connected and estimating the available output power using such a measurement.

The first power block data can also include various aspects of the first battery system. For example, the first power block data can include one or more of a battery state of charge, a battery health, a battery voltage, a battery current, a battery type, and/or a battery charge/discharge rate for each battery, for a string of batteries, a battery system, or an entire battery system of a power block. These aspects of the first battery system can be measured and/or determined using battery controllers, DC/DC converters that connect batteries to a common DC bus, and/or using various meters.

The first power block data can also include various aspects of any converter-connected components and/or any bus-connected components. For example, the first power block data can include one or more voltages, currents, power factor, energy/power consumption, energy/power generation, rate of energy/power consumption and/or generation, energy/power stored, type of energy/power storage, charge/discharge rate for each energy/power storage element, or the like. Because converter-connected components and bus-connected components are not limited, the data associated with such components, which is included in the first power block data, is similarly not limited. In general, power block data is associated with electrical measurements or determinations, though it need not be.

The first power block data can also include an available first inverter output power. In some examples, the available inverter output power can be defined as a maximum output power of the inverter in the current conditions (e.g., immediately available) and/or in future conditions (e.g., likely available in the future). The available first inverter output power can be determined by the inverter itself and/or by meters electrically connected to the inverter. The available first inverter output power can encompass all the power able to be output by components connected to the first inverter. For instance, the first inverter output power can include both available PV system power and available battery system power. In examples that use a single inverter per power block, the first inverter output power can include all the power available to be output by the power block.

Continuing with the method of FIG. 3, flow continues at 310 whereby a PPC 134 can receive second power block data from a second power block. The second power block data received from the second power block can be similar to the first power block data received from the first power block as described elsewhere herein. For instance, the second power data received from the second power block can include one or more of: an available output power of the PV system, and available battery system output power, various aspects of the battery system, various aspects of converter-connected components, various aspects of bus-connected components, or an available inverter output power for the second power block. The various aspects of the battery system can include one or more of a battery state of charge, a battery health, a battery voltage, a battery current, and/or a battery charge/discharge rate for each battery, for a string of batteries, a battery system, or an entire battery system of a power block. The various aspects of the converter-connected components and the bus-connected components are not limited.

Further in FIG. 3, flow continues at 315 with determining an optimized set of power setpoints for one or more of the power block components of the first power block (e.g., 102a) and of the second power block (e.g., 102b). The determining the optimized set of power setpoints can be based on the received first power block, the received second power block data, and the requested power plant power to supply the requested power plant power to the electrical grid. In some examples, a PPC 134 can determine the optimized set of power setpoints. An optimized set of power setpoints can include power setpoints for components of the power block.

Flow then continues at 320 with setting the one or more power setpoints for the power block components of the first power block and the second power block based on the determined optimized set of power setpoints. To set the one or more power setpoints for the power block components, in some examples, a PPC 134 can communicate with some or all of the components of the first power block and the second power block. For instance, a PPC 134 can communicate with a first inverter to set a first inverter power setpoint. The first inverter power setpoint can include setting a voltage of a DC bus connected to the first inverter. Similarly, a PPC 134 can communicate with one or more DC/DC converters connected to one or more battery systems (e.g., 114a) of the first power block to set a power setpoint for the DC/DC converters, and thus for the one or more battery systems connected thereto. In similarity with the inverter power setpoints, the one or more DC/DC converter power setpoints can include setting a voltage of the DC/DC converter (e.g., an output voltage). Further, a PPC 134 can communicate with one or more DC/DC converters connected to converter-connected components to set power setpoints for the converter-connected components. The setpoints for the converter-connected components can similarly include setting a voltage of the DC/DC converter connected to the converter-connected component(s). A PPC 134 can also communicate with one or more bus-connected components to set power setpoints of the bus-connected components. In some examples, the setpoints for the bus-connected components can include setting a voltage of the bus-connected components (e.g., higher or lower than a DC bus voltage).

While referred to in FIG. 1 as a first power block 102a, any power block of the power plant system 100 can be considered a first power block, a second power block, a third power block etc. for purposes of the methods described herein (e.g., the illustrated method of FIG. 3). For example, the first power block can include solar trackers (e.g., 110c) but exclude batteries and/or energy storage systems, as is illustrated by the fourth power block 104 of FIG. 1. Similarly, a second power block, third power block etc. can include solar trackers but exclude batteries and/or energy storage systems. Additionally, any components of any power block of the power plant system 100 can also be considered as a first component, second component, third component etc. for purposes of the methods described herein (e.g., the illustrated method of FIG. 3). For example, while a first PV system generally refers to being part of a first power block and a second PV system generally refers to being part of a second power block, a first PV system can be part of any power block and a second PV system can be part of any power block.

Referring generally to power blocks and their associated power setpoints for components contained therein, a first power block can include a first PV system, a first battery system, and at least one first inverter. Similarly, a second power block can include a second PV system, a second battery system, and at least one second inverter. A set of power setpoints for components of the first power block can include power setpoints for the first PV system, the first battery system, and/or the at least one first inverter. For example, a first PV system power setpoint, a first battery system power setpoint, and a first inverter power setpoint. The first battery system power setpoint can be based on one or more of a first battery system state of charge, a first battery system health, a first battery system voltage, a first battery system current, and/or a first battery system charge/discharge rate. A set of power setpoints for components of the second power block can include power setpoints for the second PV system, the second battery system, and/or the at least one second inverter. For example, a second PV system power setpoint, a second battery system power setpoint, and a second inverter power setpoint. The second battery system power setpoint can be based on one or more of a second battery system state of charge, a second battery system health, a second battery system voltage, a second battery system current, and/or a second battery system charge/discharge rate. A set of power setpoints for components of an “n” number of power blocks can include power setpoints for an n^{th} PV system, an n^{th} battery system, an n^{th} converter-connected component, an n^{th} bus-connected component, and/or an n^{th} at least one inverter. For example, an n^{th} PV system power setpoint, an n^{th} battery system power setpoint, and an n^{th} inverter power setpoint.

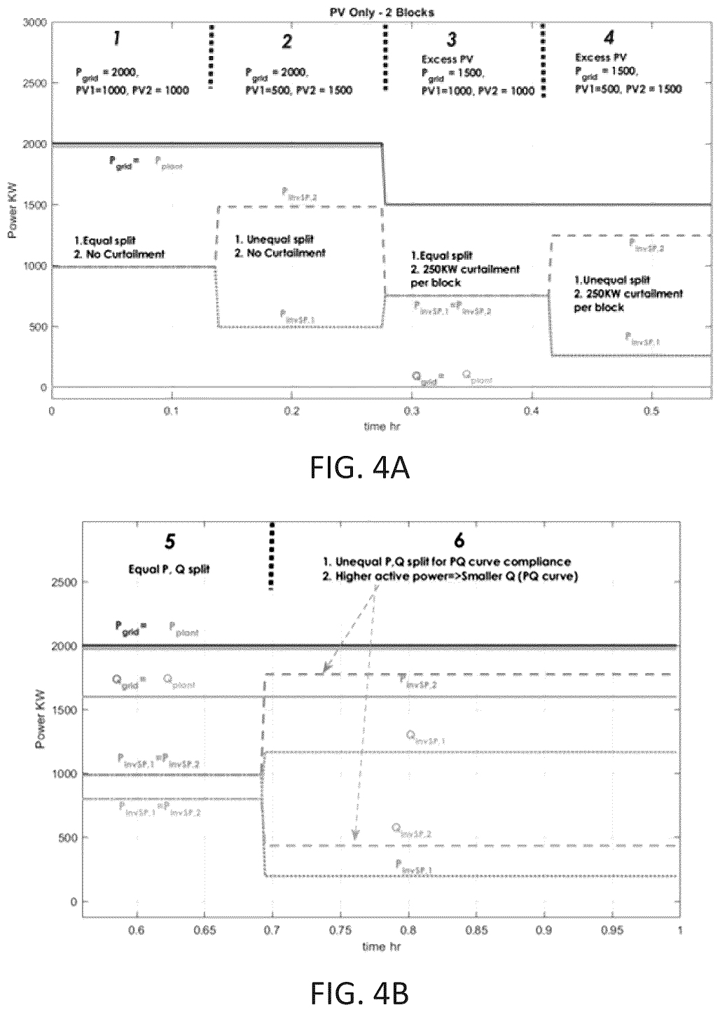

Referring to both FIG. 4A and FIG. 4B, FIG. 4A is an example graph of power provided by PV power blocks under varying conditions according to an aspect of the present disclosure and FIG. 4B is an example graph of power provided by the PV power blocks of FIG. 4A under further varying conditions. The example graph illustrates an operation of a power plant system (e.g., 100) comprising two power blocks that each include a PV system (e.g., strings of solar trackers) for generating solar power but that do not include, or do not use, a battery system. The power blocks used for the graphs of FIG. 4A and FIG. 4B can be similar in configuration to the fourth power block 104 illustrated FIG. 1. The graphs of FIG. 4A and FIG. 4B together include six distinct regions having different operating conditions.

In the first region, the grid is requesting 2000 kW of power while the first PV system of the first power block has an available 1000 kW of output power and the second PV system of the second power block has an available 1000 kW of output power. As described elsewhere herein, a PPC (e.g., 134) can receive the grid request. As the available output power of the first PV system and the available output power of the second PV system are equal and comprise half of the requested power, a PPC can set power setpoints of the first power block (e.g., first PV system power setpoint) and the second power block (e.g., second PV system power setpoint) equally split the output power provided to the grid.

In the second region, the grid is again requesting 2000 kW of power. However, the first PV system of the first power block has an available 500 kW of output power rather than the 1000 kW as in the first region while the second PV system of the second power block has an available 1500 kW of output power rather than the 1000 kW as in the first region. Accordingly, to meet the requested 2000 kW of power, a PPC can set the power setpoints of the first power block (e.g., a first inverter power setpoint) and the second power block (e.g., a second inverter power setpoint) unevenly. In order to set the power setpoints of the first power block and the second power block unevenly, the PPC receives/determines the available output power of the first power block and the available output power of the second power block. As discussed elsewhere herein, components of the power blocks such as devices that perform MPPT, meters, DC/DC converters, inverters etc. can communicate with the PPC directly or indirectly to provide the available output power of each block, or measurements for the PPC to determine the available output power of each block. If the PPC did not receive such information, the PPC may try to equally split the output power of the first power block and the second power block, resulting in curtailment of 1000 kW of power from the second power block and not failing to meet the requested 2000 kW of power by the grid. Accordingly, unevenly splitting the output power of the first power block and the second power block can advantageously reduce curtailment of power (e.g., generated by a PV system) and maximize output power of a power plant system. For example, setting a first inverter power setpoint of a first power block and a second inverter power setpoint of a second power block can prevent the first inverter and the second inverter from curtailing output power of a first power block PV system and a second power block PV system.

In the third region, the grid requests only 1500 kW of power with the first power block having 1000 kW of available output power and the second power block having 1000 kW of available output power. Because the amount of available output power of the first power block added to the available output power of the second power block is greater than the requested power, and because neither the first power block nor the second power block includes energy storage, some amount of available output power will be curtailed. As both the first power block and the second power block have the same available output power of 1000 kW, a PPC can set power setpoints of each block to evenly split output power and evenly split curtailment of output power. In other words, each power block provides 750 kW of output power and curtails 250 kW of power.

In the fourth region, the grid again requests only 1500 kW of power with the first power block having 500 kW of available output power and the second power block having 1500 kW of available output power. Again, as the total available output power is greater than the requested power (e.g., 2000 kW vs. 1500 kW), some amount of available output power will be curtailed. In this case, a PPC can unevenly split the power provided by each block by setting the power setpoints of the first power block and the second power block differently. However, in the fourth region, the PPC evenly splits the curtailment of each power block (e.g., 250 kW per block). Thus, the second power block curtails less of its output power than the first power block curtails of its output power (e.g., 250 kW of 1500 kW vs. 250 kW of 500 kW). This can be advantageous as maintaining a higher output power of the power block having greater available output power can have increased efficiency (e.g., due to loading of connected inverter). In some examples, though, the PPC can unevenly split the curtailment of each power block. For instance, in the fourth region, the PPC could curtail all 500 kW of the first power block and enable the second power block to provide all the output power to the grid. Alternatively, the PPC could curtail 500 kW of the second power block and not curtail the first power block at all. Other curtailment splits are contemplated.

In the fifth region, the grid requests a total active power of 2000 kW and a total reactive power of approximately 1600 kVar. In the example, the first power block and the second power block each have 1000 kW of available active output power and 800 kVar of available reactive output power. Accordingly, a PPC can set power setpoints of each block to evenly split active output power and reactive output power.

In the sixth region, the grid again requests a total active power of 2000 kW and a total reactive power of approximately 1600 kVar. However, the second power block has an increased amount of available active output power relative to the fifth region, approximately 1750 kW. As discussed with respect to FIG. 2, in some examples, a power block can be limited to a maximum amount of reactive output power relative to its active output power and a maximum amount of active output power relative to its reactive output power. For instance, if the amount of active power exceeds a threshold, the amount of reactive power may need to decrease due to possible thermal issues/damage to equipment. Accordingly, in the example illustrated in the sixth region, the second power block is limited to provide approximately 400 kVar of reactive power. However, as the grid still requests approximately 1600 kVar, the first power block may need to make up the difference. Accordingly, a PPC can set power setpoints of the first power block and the second power block to unevenly split active power and reactive power. In particular, the PPC can set a power setpoint of the first power block to decrease its active output power and increase its reactive output power to meet the grid demand relative to the available active output power and available reactive output power of the second power block. In this case, the first power block can reduce its active output power to approximately 250 kW and increase its reactive output power to approximately 1200 kVar. Unevenly splitting active power and reactive power between power blocks can be advantageous for many reasons including increasing an efficiency of a power block able to provide the largest amount of active power and meeting grid demands.

While specific values for time and power are illustrated in the example graphs of FIGS. 4A and 4B, the specific values are merely for illustration purposes and are not to be viewed as limiting this disclosure.

Referring generally to the examples of FIG. 4A and FIG. 4B, power setpoints of a first power block can be set differently than power setpoints of a second power block. Differences between power setpoints of the first power block and power setpoints of the second power block are not limited and can be 10% or greater, including up to an undefined amount greater. For instance, in the case of power setpoints where first power setpoints enable a first power block to output power greater than zero and the second power setpoints prevent a second power block from outputting power. In an example a first PV system power setpoints is different from a second PV system power setpoint and in some examples, the difference is 10% or greater. In another example, a first battery system power setpoint is different from a second battery power setpoint and in some examples, the difference is 10% or greater. In another example, a first inverter power setpoint is different from a second inverter power setpoint and in some examples, the difference is 10% or greater.

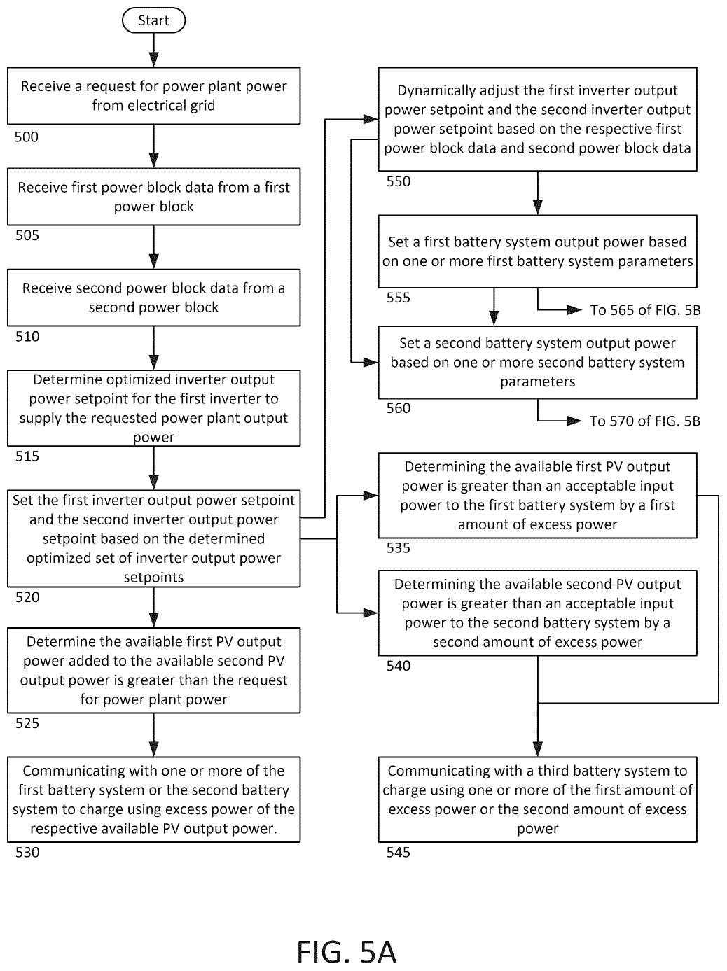

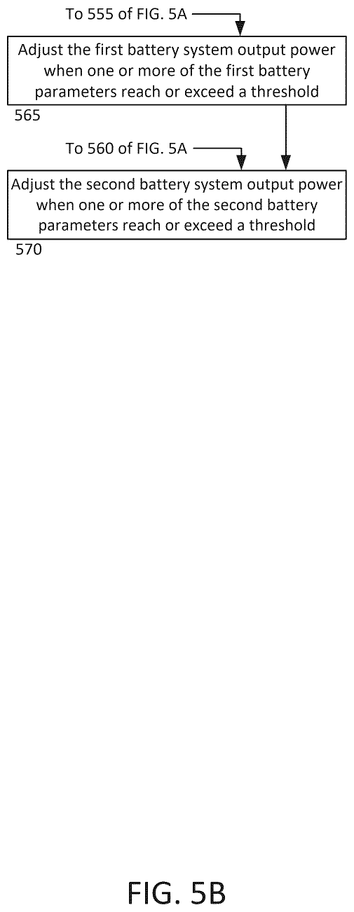

Referring to both FIG. 5A and FIG. 5B, FIG. 5A is a flow diagram of an alternate example method of optimized control of setpoints in a power plant according to an aspect of the present disclosure and FIG. 5B is a continuation of the flow diagram of FIG. 5A. In some examples, a PPC (e.g., 134 of FIG. 1) can be configured to perform the example method of FIG. 5A. Flow of the method can start at 500 with receiving a request for power plant power from an electrical grid. In some examples, the request for power plant power can include both active and reactive power (e.g., apparent power).

Flow continues at 505 with receiving first power block data from a first power block. As described elsewhere herein, a first power block can include a first PV system, a first battery system, a first converter-connected component, a first bus-connected component, and/or a first inverter. Flow continues at 510 with receiving second power block data from a second power block. As described elsewhere herein, a second power block can include a second PV system, a second battery system, a second converter-connected component, a second bus-connected component, and/or a second inverter.

Flow continues at 515 with determining an optimized set of inverter power setpoints to supply the requested power plant output power. The optimized set of inverter power setpoints is based on one or more of the first power block data, the second power block data, and/or the requested power plant output power. The optimized set of inverter power setpoints can include a first inverter power setpoint and a second inverter power setpoint. In some examples, determining the optimized set of inverter power setpoints includes determining a first amount of real power and a first amount of reactive power to be provided by a first PV system and/or a first battery system. Further, in some examples, determining the optimized set of inverter power setpoints includes determining a second amount of real power and second amount of reactive power to be provided by a second PV system and/or a second battery system. In some cases, the first amount of real power can be greater than the second amount of real power with the first amount of reactive power being less than the second amount of reactive power.

Flow continues at 520 with setting the first inverter power setpoint and the second inverter power setpoint based on the determined optimized set of inverter power setpoints. In some examples, setting the first inverter power setpoint and the second inverter power setpoint can include setting power setpoints for one or more components of the first power block or the second power block. In some examples, setting the first inverter power setpoint and the second inverter power setpoint includes setting setpoints for peripheral inverters with the first inverter and/or the second inverter being a controlling inverter.

As discussed elsewhere herein, the first power block data can include available first PV output power, available first battery system output power, various aspects of the first battery system including a first battery system state of charge, a first battery system health, a first battery system voltage, a first battery system current, a first battery type, and/or a first battery charge/discharge rate, various aspects of first converter-connected components, various aspects of first bus-connected components, and an available first inverter output power. Similarly, the second power block data can include available second PV output power, available second battery system output power, various aspects of the second battery system including a second battery system state of charge, a second battery system health, a second battery system voltage, a second battery system current, a second battery type, and/or a second battery charge/discharge rate, various aspects of second converter-connected components, various aspects of bus-connected components, and an available second inverter output power.

In some examples, the flow of the example method of FIG. 5A continues at 525 with determining the available first PV output power added to the available second PV output power is greater than the request for plant power. In some such examples, flow can further continue at 530 with communicating with one or more of the first battery system or the second battery system to charge using excess power of the respective available PV output power. For example, a PPC communicating with the first battery system to charge using excess power of the available first PV output power and/or communicating with the second battery system to charge using excess power of the available second PV output power.

In some examples, in addition to the first power block and the second power block, a power plant system can include a third power block. As described elsewhere herein, the third power block can include one or more components similar to those of the first power block and the second power block. In some examples, the third power block can include a third inverter and a third battery system, though it need not include a third PV system. In some such examples, the third power block can be used to receive excess power from one or more of the first power block or the second power block and charge its third battery system.

The flow of FIG. 5A can include, at 535, determining the available first PV output power is greater than an acceptable input power to the first battery system by a first amount of excess power. The flow of FIG. 5A can also include, at 540, determine the available second PV output power is greater than an acceptable input power to the second battery system by a second amount of excess power. From either or both of these steps, flow can continue at 545 with communicating with a third battery system to charge using one or more of the first amount of excess power or the second amount of excess power. In some examples, communicating with the third battery system of the third power block includes setting third power setpoint(s) of a third power block to accept excess power from the first power block and/or the second power block.

It can be advantageous to use a third power block to charge using excess power of the first power block and/or second power block. In an illustrative example, a first PV system is generating PV power, providing the PV power to a grid via a first inverter, and the generated PV power is greater than can be stored in a first battery system (e.g., due to amount of total power or limited rate of charging). In the same example, a second PV system is generating PV power and providing the PV power to the grid via a second inverter. However, because the second PV system is providing the PV power to the grid via the second inverter, the second inverter may not be able to accept excess power from the first PV system of the first block due to conflicting power directions. However, in such an example, a third power block including a third battery system, which is not actively providing power to the grid, can accept excess PV power generated by the first PV system and charge its third battery system. If the second PV system is generating excess PV power, the third power block can, in addition to or in lieu of accepting excess PV power of the first PV system, accept excess PV power of the second PV system.

Continuing with the method of FIG. 5A, flow can include at 550, dynamically adjusting the first inverter power setpoint and the second inverter power setpoint based on the respective first power block data and second power block data. Dynamically adjusting the first inverter power setpoint and the second inverter power setpoint can include changing such setpoints over time in response to changing first power block data and second power block data.

The method of FIG. 5A can also include at 555, setting a first battery system output power based on one or more first battery system parameters. In some examples, setting a first battery system output power is performed by setting a first battery system power setpoint of a DC/DC converter (e.g., 116a). As discussed elsewhere herein, the battery system parameters can include one or more of the first battery system state of charge, the first battery system health, the first battery system voltage, the first battery system current, the first battery type, or the first battery system charge/discharge rate. In an example, setting a first battery system output power can be based on the first battery system's state of charge. In some examples, setting a first battery system output power is limited by the battery system parameters such as, for instance, a maximum discharge rate.

Similarly, the method of FIG. 5A can include at 560, setting a second battery system output power based on one or more second battery system parameters. In some examples, setting a second battery system output power is performed by setting a second battery system power setpoint of a DC/DC converter (e.g., 116b). As discussed elsewhere herein, the battery system parameters can include one or more of the second battery system state of charge, the second battery system health, the second battery system voltage, the second battery system current, the second battery type, or the second battery system charge/discharge rate. In an example, setting a second battery system output power can be based on the second battery system's state of charge. In some examples, setting a second battery system output power is limited by the battery system parameters such as, for instance, a maximum discharge rate.

The method can further include at 565 and 570, as illustrated in FIG. 5B, adjusting the first battery system output power when one or more of the first battery parameters reach or exceed a threshold and adjusting the second battery system output power when one or more of the second battery parameters reach or exceed a threshold. The adjustment to the first battery system output power and/or the second battery system output power can include increasing, decreasing, or maintaining the same output power. For instance, if a first battery parameter includes a battery health, and the battery health drops below a threshold of 50%, the first battery output power can be decreased. The adjustments to the first battery system output power can be performed by adjusting a first inverter power setpoint and/or adjusting a first DC/DC converter power setpoint. Similarly, the adjustments to the second battery system output power can be performed by adjusting a second inverter power setpoint and/or adjusting a second DC/DC converter power setpoint.

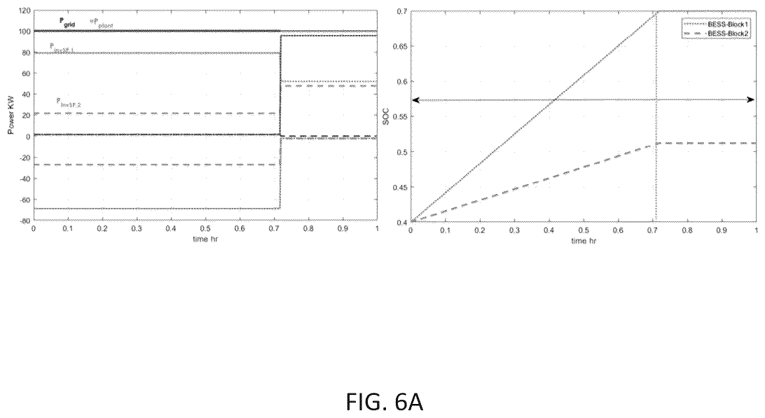

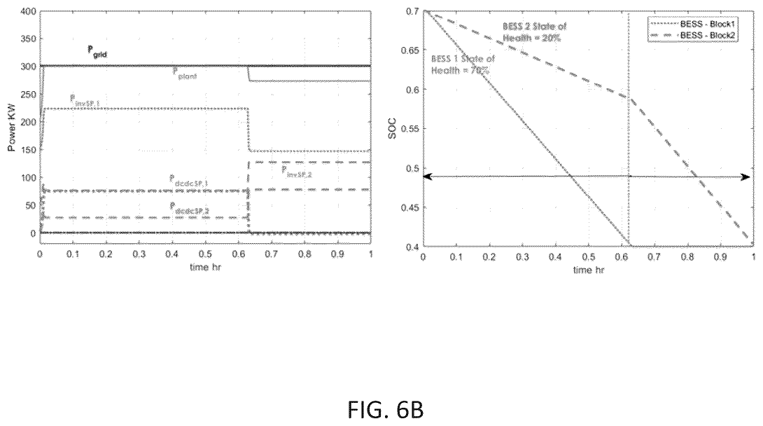

Referring to FIG. 6A, FIG. 6A is an example graph of power provided by a power plant system including batteries under charging conditions according to an aspect of the present disclosure. In the illustrated example, the power plant system (e.g., 100 of FIG. 1) includes a first power block and second power block with each of the first power block and the second power block including PV systems and battery systems (e.g., 114a/114b of FIG. 1). Throughout the graph, the grid is requesting the same amount of power, approximately 100 kW. In the first portion of the graph, the first PV system has approximately 150 kW of available output power and the second PV system has approximately 50 kW of available output power. Because the total power requested by the grid is less than the power of the combined first PV system output and the second PV system output, the batteries associated with each power block can be charged. While the battery systems could be charged at the same rate, in the illustrated example, BESS-Block 2 (i.e., the second battery system) has a degraded battery health of approximately 20% while BESS-Block 1 (i.e., the first battery system) has a degraded battery health of approximately 70%. Accordingly, a PPC (e.g., 134 of FIG. 1) can charge the second battery system at a reduced rate to conserve the second battery's health while charging the first battery system at a normal rate or slightly reduced rate. As illustrated, the first battery system charges at approximately 75 kW while the second battery system charges at approximately 25 kW. At approximately 0.7 hours, the first battery system can be fully charged, where fully charged is defined as having a state of charge of 0.70 (i.e., 70% of total capacity) to prevent the first battery system from degrading. At this time, while the second battery system may be able to accept more charge, a PPC can set power setpoints of the first power block and the second power block to stop charging and to curtail the excess PV power generated by the first PV system and the second PV system. This can be due to the PPC prioritizing the health of the second battery system more than reducing curtailment of PV power. However, in some examples, the PPC can set power setpoints of the first power block and the second power block to stop charging the first battery system and continue charging the second battery system to reduce the curtailment of PV power generated by the second PV system.

Referring to FIG. 6B, FIG. 6B is an example graph of power provided by the power plant system of FIG. 6A including batteries under discharging conditions according to an aspect of the present disclosure. Throughout the graph, the grid is requesting the same amount of power, approximately 300 kW. Similarly, throughout the graph, the first PV system of the first power block produces 150 kW and the second PV system of the second power block produces 50 kW. Further, in the illustrated example, both the first battery system of the first power block and the second battery system of the second power block are fully charged at a state of charge of approximately 0.70 (i.e., 70% of total capacity). However, the second battery system again has a degraded battery health of approximately 20% while the first battery system has a degraded battery health of approximately 70%. Accordingly, while a PPC could discharge both the first battery system and the second battery system at the same rate, to reduce the further degradation of the second battery system, the PPC can limit the discharge rate of the second battery system further than limiting, if at all, the discharge rate of the first battery system. In the illustrated example, the PPC can set power setpoints for the first power block and the second power block to meet the grid demand of 300 kW using: all 150 kW output by the first PV system, approximately 75 kW output by the first battery system, all 50 kW output by the second PV system, and approximately 25 kW output by the second battery system. However, once the first battery system is fully discharged, as defined by having a state of charge of approximately 0.40 (i.e., 40% of total capacity) to prevent degradation, it may be difficult for the PPC to meet the grid demand. Accordingly, the PPC can prioritize meeting the grid demand at the expense of discharging the second battery system at a higher rate than previously, which may degrade the second battery system more quickly than it otherwise would. As illustrated, at such a time, the second battery system can discharge at a rate of approximately 75 kW to attempt to meet the grid demand. In this case, the grid demand is greater than the total output power of the power plant system once the first battery system is fully discharged. Further, once the second battery is fully discharged, as defined by having a state of charge of approximately 0.40 (i.e., 40% of total capacity), the power plant system will fall further short of meeting the grid demand.

Referring to both FIG. 6A and FIG. 6B, while the battery systems are described as being charged and discharged at different rates due to differing battery health, other aspects of a battery system can contribute to the charge/discharge rate of such a system. For instance, the one or more of a battery system's state of charge, a battery system's voltage, a battery system's current, a battery system's type, or a battery system's maximum charge/discharge rate can contribute to the charge/discharge rates of the battery system.

Moreover, while described as battery systems, the first battery system and the second battery system can include any type of energy storage system. For example, the first and/or second battery system can include flow batteries (e.g., vanadium flow batteries) hydrogen generation (e.g., electrolysis), pumped hydro, mechanical storage (e.g., flywheels), thermal storage, and/or others. Aspects (e.g., measurements) of such energy storage can influence charge/discharge rates and the determination of whether to charge, discharge, or maintain the energy stored in an energy storage system. For example, mechanical energy storage (e.g., flywheels) may be able to respond to a demand for energy more quickly than pumped hydro energy storage. Accordingly, a PPC can be configured to store energy in a mechanical energy storage system before, or more quickly than, storing energy in a pumped hydro energy storage system. In another example, a first battery system can comprise lithium-ion type batteries while a second battery system can comprise lead-acid type batteries. In this example, the first battery system may be able to respond to a demand for energy more quickly than, and/or more energy capacity than, the second battery system. Accordingly, a PPC can be configured to store energy in the first battery system before, or more quickly than, storing energy in the second battery system. While the first battery system and the second battery system are described as being used in the illustrated example of FIG. 6A and FIG. 6B, one or more converter-connected components and/or one or more bus-connected components can be used instead of, or in conjunction with, the first battery system and the second battery system.

Referring generally to FIG. 6A and FIG. 6B, a PPC can determine an optimized set of power setpoints (e.g., inverter power setpoints) based on first power block data (e.g., first battery system state of charge, first bus-connected component load), second power block data (e.g., second battery system state of charge, second bus-connected component load), and/or based on the requested power plant output power (e.g., grid demand). In some examples, a PPC can ignore or de-emphasize some aspects of the power plant system and can prioritize other aspects of the power plant system. In an example, a PPC can determine an optimized set of power setpoints based on first power block data and the requested power plant output power, but not on the second power block data. Similarly, in an example, a PPC can determine an optimized set of power setpoints based on second power block data and the requested power plant output power, but not on the first power block data. In an example, a PPC can determine an optimized set of power setpoints based on the first power block data and the second power block data, but not the requested power plant output power. For each of these examples, the PPC can prioritize data of one or more of the first power block, the second power block, or the requested power plant output power while ignoring or de-emphasizing data of the corresponding one or more of the first power block, the second power block, or the requested power plant output power. Such flexibility of prioritization is advantageous. For instance, a power plant than can prioritize meeting grid demand can increase total output power and revenue from the power. In another example, a power plant that can prioritize battery considerations (e.g., battery state of charge, battery health) can decrease costs associated with batteries and prolong their lifespan. In yet another example, a power plant that can prioritize meeting a converter-connected or bus-connected load can increase a reliability of power provided to the connected load. As will be appreciated, other prioritizations can lead to other advantages for a power plant system and this disclosure is not limited to the above-described examples of prioritizing some aspects of a power plant system.

While specific values for time and power are illustrated in the example graphs of FIGS. 6A and 6B, the specific values are merely for illustration purposes and are not to be viewed as limiting this disclosure.

While a specific flow of method steps is illustrated in the example flow diagrams, the order of method steps is not limited to the illustrated examples. In some examples, one or more of the method steps occur in a different order and in some examples, one or more of the method steps can occur simultaneously. Further, one or more of the method steps may be a subprocess of one or more other method steps.

Throughout this disclosure, when referring to a power plant controller (PPC), a person having ordinary skill in the art will appreciate that any controller or number of controllers implementing one or more methods (e.g., software, algorithms) can be used and that any particular reference to a PPC does not limit the disclosure to a specific implementation of a PPC. Further, while a PPC may be disclosed as performing a particular function or method step, it will be understood that a PPC can include a processor configured to receive instructions that, when executed by the processor cause the PPC to perform the function or method step or alternatively, cause the PPC to indirectly perform the function or method step (e.g., via controlling another aspect of the system). In some examples, a PPC can include a computer-readable medium to store such instructions while in some examples, a PPC is in communication with such a computer-readable medium. In some examples, a PPC can include one or more remote devices.

Various examples have been described. These and other examples are within the scope of the following claims.

1. A method of optimized control of setpoints in a power plant, comprising:
receiving a request for power plant power from an electrical grid;
receiving first power block data from a first power block;
receiving second power block data from a second power block,
each of the first power block and the second power block including power block components, the power block components including a PV system, an energy storage system, and at least one inverter,
the PV system being controllable to output power up to a PV system available output power, the energy storage system being controllable to output power up to an available energy storage system output power, and
the power block data including PV system available output power, available energy storage system output power, and inverter power output;
determining an optimized set of power setpoints for one or more of the power block components of the first power block and of the second power block based on the received first power block data, the received second power block data, and the requested power plant power to supply the requested power plant power to the electrical grid; and
set the one or more power setpoints for the power block components of the first power block and the power block components of the second power block based on the determined optimized set of power setpoints.

2. The method of claim 1, wherein the optimized set of power setpoints comprise:
a first power block set of setpoints, the first power block set of setpoints including:
a first PV system power setpoint; and
a first energy storage power setpoint;
a second power block set of setpoints, the second power block set of setpoints including:
a second PV system power setpoint; and
a second energy storage system power setpoint.

3. The method of claim 2, wherein the first PV system power setpoint is different from the second PV system power setpoint by at least a difference of 10%.

4. The method of claim 2, wherein the first energy storage system power setpoint is different from the second energy storage system power setpoint.

5. The method of claim 4, wherein a difference between the first energy storage system power setpoint and the second energy storage system power setpoint is 10% or greater.

6. The method of claim 2, wherein:
the first power block set of setpoints further includes a first inverter power setpoint; and
the second power block set of setpoints further includes a second inverter power setpoint, the first inverter power setpoint different from the second inverter power setpoint.

7. The method of claim 6, wherein a difference between the first inverter power setpoint and the second inverter power setpoint is 10% or greater.

8. The method of claim 6, wherein setting the first inverter power setpoint and the second inverter power setpoint prevents the first inverter and the second inverter from curtailing output power of the first power block PV system and the second power block PV system.

9. The method of claim 2, wherein:
the first power block set of setpoints further includes one or more of a first converter-connected component power setpoint or a first bus-connected component power setpoint; and
the second power block set of setpoints further includes one or more of a second converter-connected component power setpoint or a second bus-connected component power setpoint.

10. The method of claim 9, wherein:
the one or more of the first converter-connected component power setpoint or the first bus-connected component power setpoint comprises a first electrical load setpoint; and
the one or more of the second converter-connected component power setpoint or the second bus-connected component power setpoint comprises a second electrical load setpoint.

11. The method of claim 1, wherein:
the first energy storage system comprises a first battery system and the second energy storage system comprises a second battery system; and
the optimized set of power setpoints comprise:
a first power block set of setpoints, the first power block set of setpoints including:
a first PV system power setpoint; and
a first battery system power setpoint;
a second power block set of setpoints, the second power block set of setpoints including:
a second PV system power setpoint; and
a second battery system power setpoint.

12. The method of claim 11,, wherein the first battery system power setpoint is based on one or more of a first battery system state of charge, a first battery system health, a first battery system voltage, a first battery system current, a first battery type, or a first battery system charge/discharge rate.

13. The method of claim 11, wherein the second battery system power setpoint is based on one or more of a second battery system state of charge, a second battery system health, a second battery system voltage, a second battery system current, a second battery type, or a second battery system charge/discharge rate.

14. The method of claim 1, wherein the power block components within each power block are coupled to a common DC bus.

15. The method of claim 14, wherein the PV systems of the first power block components and the second power block components each include one or more maximum power point tracking devices.

16. An optimized setpoint control system for a power plant, comprising:
a first power block configured to generate first power block data, the first power block data including available first inverter output power, the first power block including:
a first PV system;
a first energy storage system; and
a first inverter coupled to the first PV system and the first energy storage system on a common DC bus, the first inverter configured to output available first inverter output power;
a second power block configured to generate second power block data, the second power block data including available second inverter output power, the second power block including:
a second PV system;
a second energy storage system; and
a second inverter coupled to the second PV system and the second energy storage system on a common DC bus, the second inverter configured to output available second inverter output power;
a controller programmed with instructions to perform the following:
receive a request for power plant power from an electrical grid;
receive the first power block data;
receive the second power block data;
calculate an optimized set of inverter power setpoints to supply the requested power plant power based on the received first power block data, the received second power block data, and the requested power plant power, the optimized set of inverter power setpoints including a first inverter power setpoint and a second inverter power setpoint; and
set the first inverter power setpoint and the second inverter power setpoint based on the determined optimized set of power setpoints.

17. The system of claim 16, further comprising:
a third power block configured to generate third power block data, the third power block data including available third inverter output power, the third power block including:
a third energy storage system; and
a third inverter coupled to the third energy storage system on a common DC bus, the third inverter configured to output available third inverter output power.

18. The system of claim 17, wherein:
the first power block data includes available first PV output power;
the second power block data includes available second PV output power; and
the controller is further programed with instructions to:
determine the available first PV output power added to the available second PV power is greater than the request for the power plant power;
communicate to the first energy storage system to charge using excess power of the available first PV output power; and
communicate to the second energy storage system to charge using excess power of the available second PV output power.

19. The system of claim 18, wherein the controller is further programmed with instructions to:
determine the available first PV output power is greater than an acceptable input power to the first energy storage system by a first amount of excess power; and
set a third inverter power setpoint to accept the first amount of excess power for charging the third energy storage system.

20. The system of claim 18, wherein the controller is further programmed with instructions to:
determine the available second PV output power is greater than an acceptable input power to the second energy storage system by a second amount of excess power; and
set a third inverter power setpoint to accept the second amount of excess power for charging the third energy storage system.
